(19) United States
(12) Patent Application Publication
(10) Pub. No.: US 2023/0081051 A1
(43) Pub. Date: Mar. 16, 2023

(54) SYSTEMS AND METHODS USING INVENTORY DATA TO MEASURE AND PREDICT AVAILABILITY OF PRODUCTS AND OPTIMIZE ASSORTMENT

(71) Applicant: 3M INNOVATIVE PROPERTIES COMPANY, St. Paul, MN (US)

(72) Inventors: Brian E. Brooks, St. Paul, MN (US); Sean T. Kalafut, Minneapolis, MN (US); Frederick J. Arsenault, Stillwater, MN (US); Peter G. Klink, St. Paul, MN (US); Nicholas A. Johnson, Woodbury, MN (US); Todd A. Braunlich, Prescott, WI (US); Ryan M. Pfalz, Minneapolis, MN (US)

(21) Appl. No.: 17/796,744

(22) PCT Filed: Feb. 24, 2021
(86) PCT No.: PCT/IB2021/051554

§ 371 Date: Aug. 1, 2022

Related U.S. Application Data
(60) Provisional application No. 62/981,717, filed on Feb. 26, 2020.

(51) Int. Cl. G06Q 10/08; G06Q 30/02

(52) U.S. Cl. CPC G06Q 10/087; G06Q 30/0205

(57) ABSTRACT

A method is provided that comprises determining a first time period during which a first product is available in an inventory at a point of purchase according to a model that uses (a) sales data, (b) inventory data, or (c) both sales data and inventory data. The inventory data comprises data from an inventory management system, sampled during the first time period, as an input. The method further comprises determining a second time period during which the first product is unavailable in the inventory according to the model and comparing a first time period sales data to a second time period sales data to determine a product unavailability effect. The method also comprises using the product unavailability effect to change an assortment at the point of purchase.

### SUMMARY

In one aspect, the present disclosure provides a method comprises determining a first time period during which a first product is available in an inventory at a point of purchase according to a model that uses (a) sales data, (b) inventory data, or (c) both sales data and inventory data. The inventory data comprises data from an inventory management system, sampled during the first time period, as an input. The method further comprises determining a second time period during which the first product is unavailable in the inventory according to the model and comparing a first time period sales data to a second time period sales data to determine a product unavailability effect. The method also comprises using the product unavailability effect to change an assortment at the point of purchase.

In another aspect, the present disclosure relates to a system comprising an inventory management system that tracks inventory data of a first product at a point of purchase and an inventory prediction model operable via a processor and configured to predict periods of unavailability of the first product using the inventory data, the periods of unavailability based on a probability that the product is unavailable and, based on a relationship between changes in the inventory of a second product during the periods of unavailability of the first product, form a prediction of a product unavailability effect in sales data of the first product and the second product. The system further comprises a user interface configured to receive input from a user entered via the user interface and operable to facilitate predicting, via the inventory prediction model, the product unavailability effect.

In another aspect, an inventory management system tracks inventory data of all products at a point of purchase over time. An inventory prediction model is operable via a processor and configured to predict periods of unavailability of each product using the inventory, sales and other data. The periods of availability and unavailability are predicted based on probabilities that each product is unavailable, even if the inventory management system indicates that the product is available. Based on the relationships between changes in the inventory of other products during the periods of unavailability, the inventory prediction model predicts the probabilities of customers substituting other products in place of unavailable ones. The system may also include a user interface operable to facilitate recommending, via the inventory prediction model, changes to an assortment at the point of purchase comprising any combination of current products, and others not yet offered.

### BRIEF DESCRIPTION OF THE DRAWINGS

The discussion below makes reference to the following figures, wherein the same reference number may be used to identify the similar/same component in multiple figures.

FIG. 1 is a graph showing inventory data analyzed by a system according to an example embodiment;

FIG. 2 is a graph showing periods during which substitution behavior can be analyzed by a system according to an example embodiment;

FIGS. 3 and 4 are a table and graphs showing modeling of substitution probabilities for a set of products according to an example embodiment;

FIG. 5 is a flowchart showing processing within a system according to an example embodiment;

FIG. 6 is a block diagram of a system according to an example embodiment;

FIGS. 7-9 are flowcharts of methods according to example embodiments; and

FIG. 10 is a graph showing a comparison between product counts in an inventory management system, audited counts, and predicted counts using a machine-learning system according to an example embodiment.

### DETAILED DESCRIPTION

The success of a retailer may depend in part on offering an appealing set of products (the assortment) to consumers. For any retailer, correctly optimizing assortment across all points of purchase (PoPs—for example, individual physical stores, distribution centers, e-Commerce websites) could yield significant improvements in business performance. Optimizing the set of available products at each PoP can help customers to spend less time searching for the product(s) that best suit their needs, which is a more enjoyable shopping experience for the consumer that increases the likelihood that the consumer will return to the retailer. Further, a retailer could increase unit sales of higher price and/or more profitable products by removing inexpensive and/or less profitable products, or the retailer could reduce supply chain costs and out of stock occurrences by only stocking and/or giving more inventory capacity to certain key products at each PoP.

An assortment, as the term is used herein, generally refers to the collection of goods and services that a business offers to a consumer. This term can encompass the number of products as well as the variety of products. The term variety of products may refer to packaging size or package product count, brands offered, or the like.

Currently, systems exist that help retailers estimate how changes in assortment will affect sales. These systems may utilize demographic, psychographic and economic information for particular geographic regions, as well as sales data from the same or similar regions. Even though such current systems can use advanced multivariate statistical and machine learning/artificial intelligence methods to predict customer responses to changes, their predictions can be subject to high levels of uncertainty due to the paucity of data generated by these studies, which are typically designed as A/B tests (also known as bucket testing or split run testing). Such data gathering may consist of designing two different starting assortments and measuring the resulting consumer behavior. These tests, however, require artificial testing design, individual set-up, and they can be expensive to run, monitor, and analyze, thus limiting the benefits of such assortment optimization testing processes.

In contrast, in one embodiment, the present description is directed to a method that can use inventory data gathered in situ, along with customer purchase patterns, to naturally observe how the availability or unavailability of a product in the course of retail operations effects consumer behavior, e.g., consumer purchase patterns. This method provides a more direct measure of assortment change (as represented by product availability or unavailability) on consumer behavior in a dynamic and naturally occurring retail environment, without the need for expensive, time-consuming, and ultimately data-poor A/B testing processes currently employed. As such, in this manner, the methods of this disclosure improve data precision in the field of assortment optimization as compared to existing techniques.

The methods described herein include, in some embodiments, changing the inventory of a product and/or making material changes to assortment. In one exemplary hypothetical application, a large international retailer that sells more than $100 billion USD of products each year could increase annual revenue by several hundred million dollars by optimizing assortment such that customers buy the same volume of products but spend 0.5% more on average across all purchases.

The challenge in optimizing assortment correctly is that the retailer should understand how customers will react to changes in assortment before those changes are made. Questions may include, (1) if new products are added to a PoP, which products will customers buy, (2) how will added products impact the purchase patterns of consumers, (3) if a product is added, and consumers change their purchase behavior because of the availability of different products, will that switching behavior lead to more or less revenue and/or profit? In an extreme case, many expensive, highly profitable products could be added to all PoP assortments and increase both revenue and profit for a few weeks or months. However, over time the reduced inventory capacity at each PoP could cause products to go out of stock more frequently, thus reducing sales, and encouraging customers to buy from another retailer. Alternatively, if existing products were removed from a PoP, customers may substitute other products, or leave the PoP and decide to make all their purchases at a different PoP, possibly at another retailer.

In another hypothetical application, 90% of all products could be removed from each PoP to simplify customer shopping experiences. This could reduce supply chain complexity, increase inventory capacity and likely reduce the amount of time products are out of stock for the remaining products at each PoP. By reducing out of stock occurrences and supply chain costs, the retailer could be more profitable for a few weeks or months. But over time, customers may switch to nearby alternative retailers to gain access to more product options that better suit their needs. The latter question—how to add or remove products from PoPs without losing customers—is of concern to every retailer. The presently described methods provide the underlying framework for successfully implementing such assortment optimization.

In the methods described herein, the sales, inventory and other data from individual PoPs can be used, in some embodiments, to determine a product unavailability effect, wherein sales from a first time period when a first product is available are compared to sales data from a second time period when a first product is unavailable. While the terms first time period and second time period are used throughout this application, it should be understood that such time periods may be, but are not necessarily, sequential in nature. While sequential and/or proximate time periods may be more instructive with regard to determining an unavailability effect, it is not necessary that such first and second time periods be sequential or even proximate.

In the simplest sense, the unavailability effect may represent the effect on overall sales when a first product is unavailable to a consumer. As further described herein, the product unavailability effect, optionally in combination with other information such as customer survey data, customer demographic data, customer psychographic data, and the like, can be used to generate predicted consumer behaviors when specific products cycle between being available and unavailable for purchase (which predicted consumer behaviors may be broader or more specific than the directly observed changes in sales data for the PoP).

In some embodiments, the framework described herein may use a model that takes as input the current and historical inventory and sales data from an inventory control system. The model can also use other data, such as demographic information and inventory and sales data from other PoPs, to identify covariate variables in many-dimensional space. This model can be used to predict how changes in assortment (e.g., addition or removal of items from the PoP) can affect purchasing decisions over time and to estimate the monetary impact of implementing the new assortments at the PoP over different time horizons. This model may also generate additional predictions that improve business performance that are not explicit assortment change recommendations, such as identifying erroneous data in an inventory management system and identifying specific PoPs and products for which inventory audits would maximally inform inventory availability predictions and assortment change recommendations.

In one aspect, the methods described herein may use the data from automated inventory management systems, which are already employed by a retailer to monitor inventory available for purchase and to order new inventory. Even the best inventory systems cannot guarantee, however, that all products will be available at all times. In a single year for just a single product category, like household cleaning or air filtration products, across all PoPs of one retailer, there may be thousands of instances when products are temporarily unavailable, and during these instances, product unavailability effects can be measured. To date, product unavailability has been treated by retailers as a failure mode to be avoided. The methods described herein, however, recognize that product unavailability represents a real-time data stream of assortment change which, when considered with associated changes in customer behavior during such unavailability (a specific example of product unavailability effect), can lead to actionable insights about assortment optimization.

As an illustration, if customers at one PoP purchase all available inventory for a product X, then product X experiences a time period during which it is unavailable to customers of that PoP. Customers who shop at that PoP during this period of unavailability will be constrained in their options, able to, for instance, (1) buy products from a different assortment excluding product X until new inventory is delivered, (2) go to another PoP or to another retailer to make a purchase, or (3) delay the purchase of product X until it is again available.

Assortment changes caused by temporarily unavailable products occur frequently. Existing inventory management systems provide no automated feedback loop to reconcile the inventory monitored by the management system (including deliveries of new inventory) with the true inventory available to customers for purchase. One resulting imprecision of this reality, referred to as “phantom inventory,” can arise when the inventory management system reports, incorrectly, that inventory is available for purchase, when in fact there is none. This could be due, for example, to input errors when entering or updating the inventory data, stock that has been misplaced or stolen, and/or stock that is in place but unlikely to be purchased (e.g., due to damage or cosmetic defects). This phenomenon can increase the amount of time when products are unavailable to a customer, and when customers are forced to buy from a changed assortment. In one aspect, techniques of this disclosure mitigate or potentially overcome the technical problem presented by the data inaccuracies of existing inventory management systems. In another aspect, techniques of this disclosure turn what has traditionally been considered a problematic situation to be avoided into a source of useful and robust data that can, when subjected to the presently described methods, lead to valuable changes to assortment.

In this disclosure, a model, one component of a larger assortment optimization framework, is described that can, based on inputs from an automated inventory management system, purchase data, and other sources, generate predictions of the amount of phantom inventory reported by the retailer's inventory management system. In addition, the model can generate temporal predictions that indicate timing information as to when products are available or unavailable, for instance due to phantom inventory or other reasons. For purposes of this disclosure, “unavailability” or “not available for purchase” is used to indicate that from the perspective of a customer, the item is not practically available. As described above, existing management systems cannot directly determine this unavailability using the available inventory amount reported by an automated inventory management system. As described below in further detail, however, techniques of this disclosure may be used to determine a probability of unavailability using data including any one or more of (1) the behavior of the model-predicted inventory amounts over time, (2) the attributes of the PoP and customers who shop there, or (3) the sales of items over time at the same and other PoPs. The computing systems of this disclosure may use the inventory prediction to provide a probability of unavailability over time, and may automatically trigger an inventory audit, order of new inventory, or other change of assortment. Inventory audits, to be conducted by people or robots, are recommended to reduce uncertainty around predictions of inventory, and to better estimate the business value of making specific assortment changes.

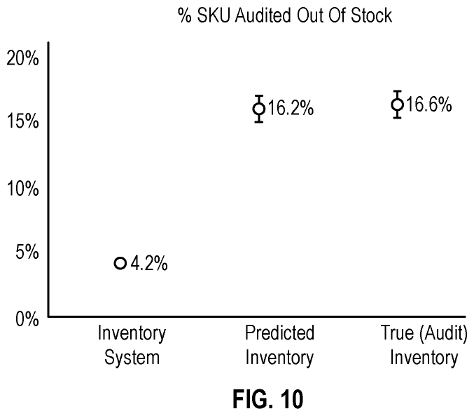

By predicting the onset time and the time duration of product(s) unavailability at a given PoP, the computing systems of this disclosure are configured to provide valuable insights into the accuracy of inventory management systems, and the magnitude of sales lost due to product unavailability. Based on real inventory audits conducted at 59 PoPs for one retailer over a four month period, a statistically significant difference was observed between the percentage of all products that are reported unavailable for purchase on the one hand, and the percentage that are truly unavailable for purchase according to the audits and the percentage that are predicted unavailable based on the methods described in this disclosure, on the other hand (see FIG. 10 and its description below). Inspecting individual product+PoP combinations that were audited substantiates the accuracy of the predictions (see Table 1). Across all PoPs associated with the same retail entity over a fixed time period, the expected amount of revenue lost due to unavailable products can be calculated by the average daily dollar sales of each product times the number of days each product is unavailable, then summed across all products at all PoPs. This summed value differs substantially between the inventory management system and the inventory prediction determined using the methods described herein (see Table 2).

In Table 1, data for actual products are shown that indicate the percentage of products (tracked using SKUs) that were truly unavailable, reported as unavailable by the automated inventory management system, and predicted as unavailable by the machine-learning systems described herein. The inventory prediction algorithms generate their predictions without requiring receipt of any information from the store audits. The data in Table 1 combines the results of three audit rounds, in which 3,919 specific products were checked at the audited PoPs. Each row in Table 1 indicates a different product at a different PoP, which were in different cities.

TABLE 1
Inventory amounts from the automated inventory management
system, audits, and inventory prediction algorithms for
specific product + PoP combinations that were audited.

| | | Inventory | | | |
|---|---|---|---|---|---|
| | | Shown | | | Predicted |
| Product + | | in Mgmt | | Predicted | Unavail- |
| PoP | Date | System | Audit | Inventory | able |
| A | Oct. 24, 2019 | 18 | 0 | 6 ± 7 | Yes |
| B | Dec. 12, 2019 | 2 | 0 | 0.3 ± 1 | Yes |
| C | Oct. 25, 2019 | 60 | 0 | 1 ± 12 | Yes |
| D | Dec. 13, 2019 | 0 | 0 | 0 ± 0.6 | Yes |
| E | Dec. 13, 2019 | 30 | 0 | 0 ± 1 | Yes |
| F | Sep. 16, 2019 | 11 | 0 | 4 ± 5 | Yes |
| G | Sep. 17, 2019 | 9 | 0 | 0 ± 2 | Yes |
| H | Sep. 16, 2019 | 24 | 0 | 0 ± 3 | Yes |
| I | Dec. 12, 2019 | 7 | 0 | 0 ± 2 | Yes |
| J | Sep. 10, 2019 | 35 | 0 | 6 ± 17 | Yes |

TABLE 2
Lost revenue due to unavailable products from a specific category
at all PoPs of one retailer. Duration was 296 days. Retailer
revenue for this category of product was $226.7 million.

| | | Lost revenue |
|---|---|---|
| Case | Method of predicting lost revenue | estimate |
| 1 | Solely using inventory system data | $2.8M |
| | | (1% of total) |
| 2 | Machine-learning enhanced on-shelf | $11.4M |
| | availability | (5% of total) |
| 3 | Machine-learning enhanced on-shelf | $6.6M |
| | availability and machine-learning | (3% of total) |
| | estimate of customer substitution | |
| | behavior | |

There are existing methods based on routine manual labor and/or robotics, optionally using computer vision, that are used to correct the inventory reported by automated systems, and to identify when products have no inventory available to customers for purchase. At the time of the filing of this patent application, however, purely robotic approaches can only reliably identify the first product on a physical shelf, but nothing behind it. Therefore, the true inventory is seldom measured accurately. Discoveries of phantom inventory by robotic methods can direct retailer employees to specific PoPs and products. Manual labor approaches that rely on people to count or check items in different locations are effective in obtaining true inventory measurements, but the high cost of labor—$100,000 or more to check all products at one PoP during one week—prohibits such approaches from being used frequently for all products across all PoPs. Systems of this disclosure can predict true and phantom inventory, and when items are unavailable to customers over any time period, for a fraction of the cost, thus giving retailer employees more time to spend on more valuable tasks, like helping customers. As such, the systems of this disclosure address the technical problem of data precision caused by existing robotics-based solutions, while reducing the costs associated with existing manual labor-based approaches. Moreover, aspects of this disclosure provide the technical improvement of enhanced data precision by way of digitally implemented system configurations, thereby reducing or potentially eliminating the need for added infrastructure in order to achieve the technical improvement of enhanced data precision.

The predicted product availability over time can be used to determine, and ultimately to predict, customer substitution behaviors when products are unavailable. Customer substitution behaviors are one type of product unavailability effect. Generally, a substitution behavior may include the purchase of another product when a first product is unavailable. While retailers would prefer that shoppers not be forced to substitute, this event (which can happen despite a retailer's best efforts) can nonetheless be an opportunity to gather valuable data to deliver better assortment to customers. For example, product unavailability effects can be used to apply changes to an assortment to optimally achieve the retailer's, manufacturer's, and other stakeholder's business goals, like increasing revenue, without losing customers. The product unavailability effects may be used to make further predictions about customer behavior, which predictions can be incorporated into a model of this disclosure which can, in turn, be used to iteratively improve prediction algorithms, and to test hypotheses about how customers respond to assortment changes.

Due to supply chain constraints, limited inventory at each PoP, phantom inventory, spontaneous customer demand and other factors, each product at any PoP over several months will likely be unavailable for purchase on at least one day to at least one customer who wanted it. A single out of stock (OOS) instance (an industry term for a type of product unavailability) may encompass the time period when the item(s) is unavailable for purchase, and the preceding and following time periods when the item(s) is available for purchase. During each period of unavailability, some embodiments of the assortment optimization framework described herein, can determine how customers respond to a specific change to a specific PoP's assortment (i.e., a product unavailability effect), for instance, either by substituting other available products, or choosing to leave the store without making a purchase. Techniques of this disclosure enable the quantification of these customer behaviors as probabilities to substitute other products in response to discovering that specific products are unavailable.

To decrease the uncertainty estimated with regard to these probabilities, the models of this disclosure may aggregate substitution behaviors across multiple PoPs that are similar, e.g., in terms of customer behaviors and PoP and customer characteristics, such as the frequency of unavailable products, demographic and/or psychographic attributes of customers, or other pertinent data. From these aggregated substitution probabilities, a type of product unavailability effect, some embodiments of the assortment optimization framework estimate the change in total number of customers (lost when a product is removed, gained when a product is added) and the change in the retailer's other business goals when a new assortment replaces the existing assortment. The assortment optimization models of this disclosure provide the added technical advantage of scalability in their ability to leverage potentially rich, voluminous data to generate probability information that targets individual scenarios involving specific products that are unavailable, specific consumers' behaviors in response to these product unavailability instances, and the like.

Optimizing assortment requires advanced knowledge of how customers will respond to assortment changes before they occur. Current state-of-the-art assortment optimization methods use past sales of each product at each PoP to calculate a per-product customer purchase preference probability, proportional to each product's relative contribution to the total sales at one PoP. Multiple PoPs that have similar current assortments and preference probabilities are assumed to serve customers with similar purchase preferences. New products are recommended across PoPs with similar customers based on business objectives such as maximizing revenue.

Current inventory management and assortment optimization methods infer the impact of assortment changes on business objectives and the fraction of customers lost when products are removed, but they do not measure it directly, resulting in less precise data for input into other systems that are used to determine optimum changes to assortment. In contrast, the systems and methods described here, which use instances of unavailable products to quantify consumer preferences in response to changing assortments, provide much more precise data for such input.

The methods described herein determine a first time period during which a a first product is available, and a second time period during which the first product is unavailable. The method also compares each PoP sales data during the first time period to the second time period sales data, for instance, such sales data may represent sales of products that could be substituted for unavailable first products. Such sales data may be analyzed to determine which products, if any, customers at each PoP are willing to substitute and with what probabilities. Using these substitution probabilities and known financial attributes of each product, some embodiments of the method further comprise calculating the impact of adding or removing each product on every business objective, including how many customers are expected to be lost or gained.

Given the time-dependent impact of adding or removing each product and the business objectives and constraints determined by a user, the methods described herein may comprise using a multi-objective optimization algorithm to calculate the best possible assortments, including per-product inventory capacity for each PoP. Calculating the best possible assortments for each PoP further comprises using variations in customer behaviors over time and using historical data to confirm that changes made during one time period continue to deliver desired results during other shorter or longer time periods. PoPs that are similar in terms of customer demographics and/or customer substitution behaviors and other attributes, PoP characteristics like assortment size, and/or product sales, may be clustered into test/control blocks where new assortments are tested iteratively. Within each block, the method comprises retaining the same assortment in a given control PoPs, while changing assortment in a test PoP. The difference in performance between a test PoP and a control PoP across all blocks can represent the current time value delivered by the assortment change.

In order to improve the accuracy of predictions of when products become unavailable and the resulting product unavailability effect, the disclosed system uses a continuously available mathematical representation of the probability that a given product is truly available to customers versus the probability of being unavailable, for any reason. To achieve this, the method may further comprise using a contingent of algorithms, disparate complimentary data sources and in-person PoP inventory audits to predict the probability that any product at any PoP is available or is unavailable.

In one embodiment, the presently described method comprises using, for each product at each PoP on a daily basis, partially observed Markov processes, and further estimating the amount of inventory available for purchase 1(t) based on the initial day reported inventory (I(t₀)), and all sales and new inventory deliveries to the PoP. These processes, represented in Eqs [6-8], estimate the initial difference (ΔDᵢₙᵢₜ) between the inventory reported by the PoP for a product and the actual amount of inventory available for purchase, and the evolution of this difference over time (Iᵣₑₚₗₑₙ(t)(1+ΔDᵣₑₚₗₑₙ(t))) caused by discrepancies between the amount of new inventory expected on delivery dates (Iᵣₑₚₗₑₙ(t)) and the unknown true amount delivered. The methods may further comprise incorporating into the Markov processes the internal metrics ℑ(t) (the fraction of actual sales that occurred through time t that cannot be met by the predicted available inventory I(t)), the average predicted inventory over recent days Iₘₑₐₙ(t), the uncertainty around the predicted inventory over recent days Iₛₑ(t), and auxiliary data (attr) that represent demographic and psychographic attributes of customers at the PoP, and sales and availability of other items at the same and other PoPs.

$$I ( t ) = {I}_{0} + Δ {D}_{i n i t} ( {t}_{0} ) + {I}_{replen} ( 1 + Δ {D}_{r e p l e n} ( t ) ) - {\sum }_{j = {t}_{0}}^{j = t} {sales}_{j} \qquad [ 6 ]$$

$${Δ D}_{i n i t} ( {t}_{0} ) = a ( 1 - ( t ) ) + {\sum }_{i = 1}^{n} {b}_{i} N ( {μ}_{i} = \frac{Δ {attr}_{i}}{{attr}_{i}} , {σ}_{i}^{2} = \frac{\vert {μ}_{i} \vert}{10} ) + {gI}_{m e a n} ( t ) + {rI}_{s e} ( t ) \qquad [ 7 ]$$

$$Δ {D}_{replen} ( t ) = {a}^{′} ( 1 - ( t ) ) + {\sum }_{i = 1}^{n} {b}_{i}^{′} N ( {μ}_{i} = \frac{Δ {attr}_{i}}{{attr}_{i}} , {σ}_{i}^{2} = \frac{\vert {μ}_{i} \vert}{10} ) + {g}^{′} {I}_{m e a n} ( t ) + {r}^{′} {I}_{s e} ( t ) \qquad [ 8 ]$$

The method further comprises fluctuating the numeric coefficients in Eqs [7-8] by a Markov chain over many iterations and minimizing the amount of predicted inventory and the uncertainty around it, while predicting sufficient inventory to meet all sales that actually occurred. The methods may further comprise using each product at a PoP, the post-Markov chain predicted inventory I(t) and its uncertainty and predicting, by day, whether a product at a PoP is available or unavailable.

The predicted available inventory and its uncertainty over time can be combined with other predictors to calculate a daily probability, and related uncertainty of the daily probability, of a product being available or unavailable. In this way, some of the implementations of the techniques of this disclosure provide granular probability information and their related uncertainty skews. By providing granular predictions and related uncertainty skews on a per-day (or per-week, per-hour, or other temporal) basis, these implementations of the techniques of this disclosure provide even further enhancements in the technical field of optimization modeling, because the granular predictive data enables the downstream inventory management systems to deliver targeted and expedient remediation measures.

For example, for each item (product) J, there are other items (products) Q, R, S, etc., at the same PoP and items {H} at other PoPs, whose historical sales and inventory replenishments covary with the same metrics for item J. A separate Markov chain algorithm can use these covariate parameters to calculate conditional probabilities that an unusually long time has passed since the last sale of, or inventory replenishment for, item J. Any other time-varying metrics, like, for example, regional air temperature and fraction of buyers who visit stores by day, or metrics that could be coerced into time varying data by sampling from a statistical distribution over time, can be included as potential covariate parameters used in this analysis. For each day, these conditional probabilities and uncertainties can be combined and weighted by the value K:

I(t)−K*δI(t)=0 [9]

The method may further comprise using equation [9] to calculate a unique probability on each day of a product being unavailable. Larger uncertainty around the predicted inventory or inferential probabilities based on other products translates directly into larger uncertainties on product availability/unavailability probabilities. The probabilities can then be converted into binary availability/unavailability classifiers using a time, PoP and a product-dependent probability threshold.

The unavailability prediction process can also elucidate which PoPs and products are persistently unavailable and provide statistical confidence regarding which of those products are predicted to be unavailable. Predictions for all products at each PoP over all time spanned by the data can be summarized using the binary classifiers and the associated probability uncertainties. The PoPs for which the value of reducing uncertainty around the predicted amount of product unavailability is maximized can be selected for in-person or robot-mediated inventory audits, where the inventory of each product is measured exactly at a single point in time. Often, the PoPs recommended for inventory audits are those where the predicted amount of product unavailability relative to the number of products offered is large relative to most other PoPs. As the predictions of inventory and product unavailability for each product at one PoP are informed by predictions made at other PoPs, the products and PoPs selected for audits are also based on predictions made at other PoPs.

In one embodiment, the methods further comprise specifying a list of PoPs and products to check, checking those PoPs by counting the inventory of a product available for customers to purchase, and recording the specific date and time when this is done. These data, as shown in Table 2, reveal the degree of error between the standard inventory management system and the truth, and provide invaluable feedback to the inventory prediction methods described herein. The audit inventory measurements can be fed back into the algorithms used in the inventory prediction methods described herein, and used to simultaneously reduce uncertainty around the daily predicted inventory and unavailability probability of each product, and to develop more precise data measuring and prediction methods, without using the audit measurements directly. The methods described herein may further comprise calculating the thresholds used to convert unavailability probabilities into binary classifiers (e.g., available or unavailable). Several rounds of audits can be conducted until the expected dollar-value gain in data precision around product unavailability predictions falls below the cost of conducting audits (typically a few hundred dollars for one hundred unique products at one PoP).

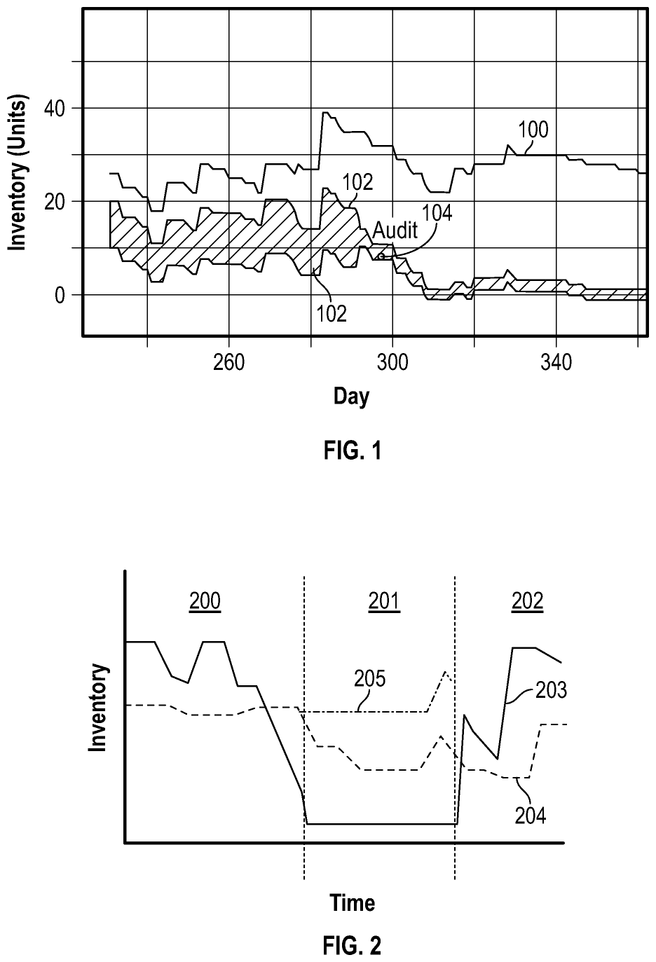

In FIG. 1, a graph shows reported inventory 100 available for purchase for one product at one point of purchase over time according to the retailer's inventory management system. Curves 102 represent inventory and uncertainty thereof predicted by the assortment optimization framework. Point 104 is an audit measurement that was shown to validate the prediction. In Table 3, results of audits are shown. On the dates when three different inventory audits were conducted at 62 different points of purchase, the audits found significantly more unavailable products than what was reported by the retailer's inventory management system.

TABLE 3

| | First Audit | Second Audit | Third Audit |
|---|---|---|---|
| # unavailable products | Round | Round | Round |
| Inventory management system | 139 | 92 | 86 |
| Audit measurement | 604 | 308 | 293 |

It will be understood that the examples using Markov models to predict product unavailability and product unavailability effects such as substitution behavior are provided for purposes of illustration and not of limitation. For example, random forest regression combined with support vector machine classification may be used instead of a hidden Markov chain model to predict when a product is unavailable for purchase. The random forest regression could utilize time-dependent variables for each product at a store such as days since the last sale and/or rolling number of inventory replenishments and rolling average daily unit sales over most recent 15, 30, and 45 days (or other increments) to calculate a score between 0 and 1 that determines the likelihood of a product being unavailable by day:

daily unavailability index˜b₁(days since last sale)+Σcᵢ(rolling number of inventory replenishments over last i days)+Σdᵢ(rolling average daily unit sales over last i days) [10]

For each product by day, this score. and optionally the chi\hat{ }2 test of proportion probability that an unusually large number of days have passed since the last sale, could be passed to a classification algorithm, such as a support vector machine, that classifies the product as available or unavailable by day (or some other relevant time period). The regression and classification algorithms could be trained using truth data generated in synthetic world simulations with realistic configuration settings, and/or audit data from real stores. Such embodiments are computationally much faster and better suited to the circumstances reflected in the synthetic world simulations. In one embodiment, the methods described herein can optimize the number of times and the time periods during which an actual inventory audit is conducted, choosing such time periods and number of audits so as to maximize the usefulness of the audit data gathered on improving the accuracy of the methods in predicting product unavailability effects.

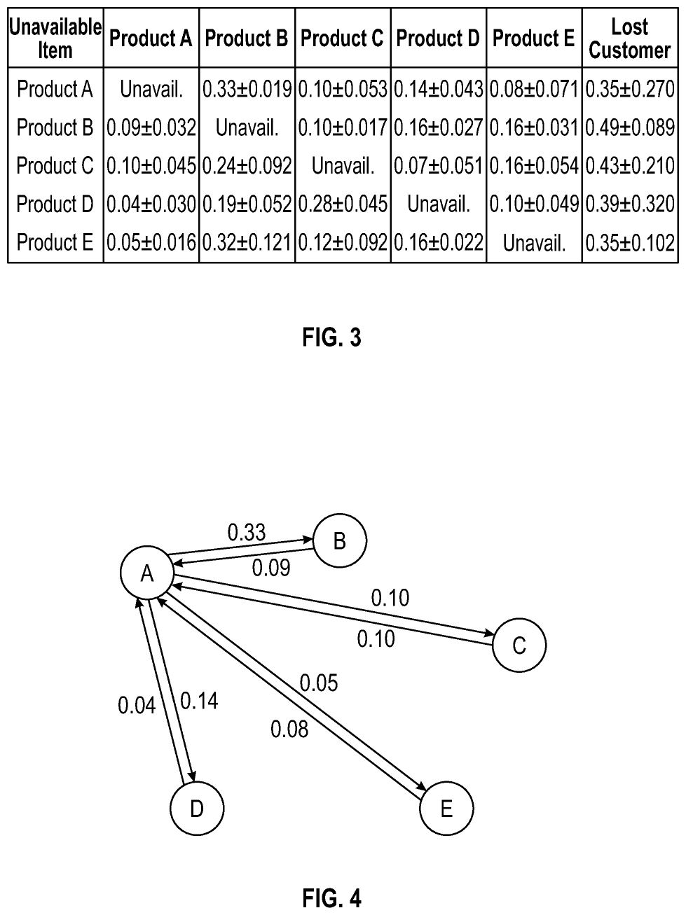

Using the availability predictions, the methods described herein can identify the most useful times, for each PoP, during which data reflecting product unavailability effects, or lack thereof, could be gathered. Each time period is identified using one or more variables from data of each PoP, including, for instance, customer demographics and sales of other products. As seen in the graph of FIG. 2, the diagnostic periods of time include a “pre” period 200 when multiple substitutable products are available. The “pre” period 200 is followed by a “during” period 201 when one or more products are unavailable. The “during” period 201 followed by a “post” period 202 when all products in the “pre” period set are again available.

The time-dependent sales patterns of each product during the “pre” and “post” periods 200, 202 are propagated into the “during” period 201 and can be compared to actual sales of each product during the unavailability time period. For example, curve 203 represents the availability of a target product that is unavailable during period 201 and curve 204 represents the availability/inventory of a substitute product. Note that during the period 201, the availability/inventory curve 204 of the substitute product exhibits a dip, indicating substitution behavior due to the unavailability of the target product.

Substitution probabilities for customers to buy an available product j in place of an unavailable product i can be calculated in the “during” period 201 using Eq. [11], and are proportional to the difference between (actual—expected) sales of available products and the expected sales of unavailable products.

$${P}_{i , j} ∼ {\sum }_{z \neq i}^{j} {c}_{z}^{′} N ( {μ}_{z} = \frac{Δ {S}_{z}}{{S}_{z}} , {σ}_{z}^{2} ) \qquad [ 11 ]$$

Here S_{z} is the expected sales of product j if product i was available, the sales deltas ΔS_{z} are (actual sales of product j when product i is unavailable)−(expected sales of product i if it was available), the coefficients c′ are calculated based on the covariance in unit sales over time between products i and j when both are predicted to be available, and the variances σ² are calculated based on the sales deltas relative to the uncertainty around the expected sales if all products were available. The expected sales of products i and j can be predicted using a regression model, such as a bagged zero inflated Poisson or random forest regression model, that uses sales and attribute data of other substitutable items in the set {z} as predictors.

For example, in FIG. 2, curve segment 205 represents the expected inventory of the substitute product, the difference between segment 205 and curve 204 in period 201 representing the product unavailability effect (in this case, a product substitution effect) from which a probability may be derived. From these substitution probabilities, the effect of removing each product at a specific PoP on each business goal, including the fraction of customers lost and change in profit, can be calculated directly. To reduce uncertainties on the predicted substitution probabilities, many PoPs can be clustered together based on similar current assortments, customer substitution behaviors, and PoP and customer attributes, and the substitution probabilities may be aggregated across all PoPs in each cluster.

In some embodiments, the methods described herein comprise clustering PoPs together in a way that maximizes the similarity between several classes of variables. Any user provided variables, such as customer demographics and PoP characteristics, can be combined with per-PoP estimates of how frequently products are unavailable for purchase, and/or during those periods, the willingness of customers to substitute any other products in aggregate, or other purchasing variables. These attributes are aligned with each PoP, and can be processed using a clustering algorithm, like k-means clustering, to identify clusters of stores that are similar in many-dimensional space. This preliminary clustering can sweep across many values of the clustering algorithm tuning parameter(s) to study the structure of cluster formation.

The preliminary cluster assignments generated by all unique sets of tuning parameter values can be refined to one optimal set of unique tuning parameter values by optimizing several competing cluster metrics. As the total number of clusters grows, the number of different PoPs in each cluster shrinks and the aggregate substitution probabilities for each cluster become more representative of the exact substitution behaviors observed at each PoP in the cluster. However, with fewer PoPs in each cluster, the uncertainty around substitution probabilities may be higher. The tradeoff between uncertainty and representative probability magnitudes can be balanced by any number of mechanisms; two general mechanisms are described here. For each unique set of cluster tuning parameter values, the aggregate mean substitution behavior for each cluster is compared to the mean substitution probabilities of a smaller randomly selected subset of its constituents. This comparison is made several times (potentially hundreds of times in some use cases), and the fraction of times when the sampled total cluster substitution probabilities fall within the randomly chosen subset's probabilities, including their uncertainties, can be maximized to ensure that each cluster's aggregate substitution probabilities are representative of most of its constituents. This maximization pushes the optimization towards many clusters with few PoPs in each. Independently, a quantity common in modern topology called persistent homology can be calculated as a function of the tuning parameters for all preliminary cluster assignments. This calculation identifies which PoPs are commonly associated together by the initial clustering algorithm, and over what range of cluster tuning parameter values the association persists. By maximizing the homology persistence and minimizing its first derivative as a function of the cluster tuning parameters, the optimal total number of clusters tends towards low values (and thus more PoPs per cluster). In one embodiment the sampled average and persistent homology mechanisms can be combined to identify one unique set of cluster tuning parameters and the total number of clusters that optimally satisfy the criteria of both mechanisms.

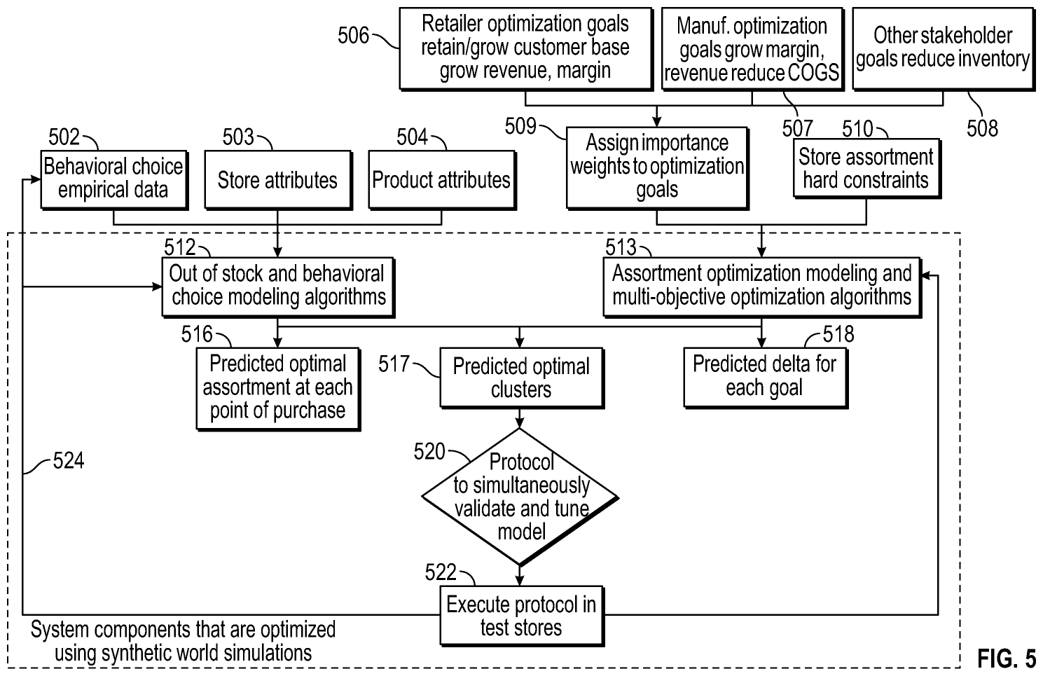

In FIG. 3, a table shows an example of substitution probabilities for an assortment of five different products. Each row represents the substitution probabilities for other products when a specific product is unavailable. Note that the right-most column indicates a probability of losing customers, such that the probabilities of each row will add up to one. The resulting aggregate substitution probabilities as shown in FIG. 3 may be used in an assortment optimization process step.

The accuracy of the optimization framework of this disclosure increases as the precision of product unavailability effects (e.g., consumer substitution estimates). Therefore, several alternate methods can be used to predict substitution probabilities. An exemplary method can either use (a) a pre-collected dataset of consumer purchases such as what products were offered and which were purchased, or (b) can actively gather data in real time and use such data to learn substitution probabilities. The method relies on an underlying assumption that consumer behavior, e.g., the probability a consumer will purchase a product when offered a set of products, will follow a multinomial logit (MNL) choice model.

The MNL model defines a positive score wᵢ for each product i, and the probability that a consumer purchases product i from a set S is computed as P(i|S)=wᵢ/sum(wⱼ) for j in S. Given such a discrete choice model, the method constructs a directed graph from the data where the nodes are the products, and a directed edge from node i to j means the consumer chose product i when offered product j. A Markov chain may be used to model the transition of consumers between nodes in the graph, and the Power Method may be used to compute the stationary distribution of this Markov chain. In FIG. 4, a graph shows the directed graph with relationships between product A and the other products B-E shown in the table of FIG. 3. There will be similar relationships between nodes B-E, although those are not shown purely for reasons of legibility.

Values of the stationary distribution are a linear function of the unknown scores wᵢ for each product. Using these weights, the method can compute consumer substitution probabilities. Comparisons are made between the substitution probabilities computed by this method and the product unavailability-based method, and against true substitution probabilities using data generated in the synthetic world. Improvements are made to both methods, and once the predictions of both methods agree within the uncertainties those methods, the final set of consumer substitution probabilities are passed to the framework. Large initial disagreements between the two methods may additionally motivate conducting inventory audits at specific PoPs.

Additional combinations of modern statistical techniques and traditional machine learning algorithms can be used to estimate customer substitution probabilities. A multivariate analysis of covariance (MANCOVA) could be used to identify which products have rolling average daily sales that covary with specific products becoming unavailable. For items {Y} whose sales do covary with other products being unavailable, sales of {Y} when no products are unavailable would be predicted by applying random forest regression to daily sales of other items {X}, wherein sales for each Y, are approximated as a sum of the weighted (by the coefficients e.g., c₁, c₂, c₃) sales of each item Xᵢ (e.g., X₁, X₂, X₃, etc):

Yᵢ sales˜c₁X₁+c₂X₂+c₃X₃+ [12]

Dividing the difference between actual and predicted sales of {Y} when other products {Z} are unavailable by the average daily sales of {Z} yields approximate substitution ratios. These ratios can be converted into substitution probabilities by generating a normalized gaussian distribution with mean zero and variance equal to the daily unit sales variance of each product in {Z} by its average daily unit sales, then integrating the gaussian from zero to the value of the ratio and multiplying the integral value by 2:

$${Z}_{j} \to {Y}_{i} probability \sim 2 * {\int }_{0}^{{Y}_{i} sales / mean {Z}_{j} sales} N ( μ = 0 , v = \frac{var ( {Z}_{j} sales )}{mean ( {Z}_{j} sales )} \qquad [ 13 ]$$

The random forest could be trained using truth data generated in synthetic world simulations with realistic configuration settings. The substitution probabilities can be used to identify specific PoPs and products from each PoP that can be removed entirely, removed partially (i.e., some of those products are removed), and/or can reallocate inventory capacity to items that would benefit the most from more capacity. This method could be much faster to generate assortment change recommendations and can recommend the highest impact assortment changes to make and/or the changes that require the least logistical effort and/or cost.

In other examples, a machine learning technique such as neural networks can be used to perform the product availability and/or product unavailability effect (e.g., product substitution behavior). For the former, a recurrent neural network may be used to predict product unavailability as a function of time based on time-varying inventory data from a target product and a substitution product. Audit data and synthetic world truth data may be used to train the network. A feed-forward neural network may be used to predict substitutions. For example, the inputs to the network could be a vector for which each element represents availability of a particular product at a point in time. This availability could be binary or could be a probability. The output of the network would be a probability vector that includes elements that correspond to the likelihood that a particular product was purchased based on the particular availability vector, e.g., sales on the same day following the point in time in which the inventory was taken/estimated. Substitution behaviors may be derived, for example, by comparing output vectors corresponding to situations when the target product is unavailable compared to situations when the substitution product is available.

Using predicted customer substitution probabilities, the assortment optimization framework may quantify the impact of adding or removing specific products from the assortment at any PoP on the retailer's business goals, including the effects of uncertainties on product unavailability and substitution predictions. Given the value the retailer places on each business goal (for example, increasing operating income may be more important than increasing revenue), the assortment optimization framework may identify top candidate assortment changes to test for each PoP that balance various business goals, and may quantify the expected change in each business goal between each recommended assortment change and the existing assortment.

To facilitate the generation of more accurate results and performance estimates from current and/or future assortment changes, assortment changes can be applied iteratively in waves, where each wave changes an assortment only at the level of a subset of all PoPs. The size of the subset can be specified by a user. In each wave, PoPs can be clustered into blocks using any clustering algorithm and any metrics, such as the k-means clustering algorithm and using as metrics any one or more of (a) the similarities between PoPs in terms of the mean expected changes in business goals from making any recommended assortment changes, (b) the products that would be affected by any recommended changes, and/or (c) the current revenues. By generating blocks in this way, different assortment change treatments can be tested simultaneously to increase the causal knowledge generated by the experiment. In each block, one or more randomly selected PoPs (the test sample(s)) receives assortment changes, and the other PoPs (control samples) receive no assortment changes that could materially affect the comparison between test and control samples. The user can specify the amount of time to test each wave of new assortments and the statistical confidence level and power required for the test, and from these quantities, the total number of blocks and PoPs per block can be derived. If the number of test PoPs where assortment changes will be made during one wave is too large to execute in a short time period (˜1 week), then the user can specify the maximum number of test PoPs per wave, and the optimization framework can adjust the block assignments. The optimization framework can additionally recommend an iterative testing strategy given just the PoPs that can be used in experiments and the total time available for experimentation. The assortment changes implemented in test PoPs are those that maximize expected business value relative to risk and, if there are multiple changes that are nearly equivalent, the changes implemented across all test PoPs can be selected to also maximize the diversity of the products affected by each treatment. After each wave of assortment changes is implemented, the framework will continue to monitor all PoPs, identify and propose new optimization opportunities to the user, and estimate the business value lost over time if no assortment changes are made.

Correctly optimizing the assortments at all PoPs of a retailer can generate value for the retailer and companies that sell products to the retailer, but incorrectly optimizing assortments can cause the retailer to lose business. Due to this high risk yet high reward nature of assortment optimization, a synthetic world was built to rigorously test the optimization framework and determine whether its recommended assortments were optimal and founded on accurate estimates of consumer substitution behaviors.

In a possible embodiment of the synthetic world, a user can specify customer attributes that define customer purchase preferences and how they respond to assortment changes. The user can specify store attributes that define how products are replenished and promoted at each store, the amount of phantom inventory for one or more products, and inject assortment changes over time.

Customer attributes defined by the system may include demographic information such as income, age, ethnicity/race, gender, education, and the like. Other, non-demographic information may also be used, such as amount of customer traffic, time of year (e.g., low or high shopping seasons), and the like. Some store attributes may be applied to individual products (e.g., preferential placement), prices, promotional signs, and the like. Other store attributes may be applied to groups of products or all products, e.g., restock frequency, geolocation, and the like.

In some embodiments, a two-stage system of algorithms can be used to ensure that each PoP in the synthetic world has a single true optimal assortment that reflects the unique purchase preferences and attributes of the PoP's customers and products that could be offered. This system operates on store groups that are built by the user, and for each store group, the first stage randomly picks between 1 and 10 multiplets (pairs, triplets, quadruplets, and the like) of customer attributes that, through multi-way statistical interactions, can adjust the value of each customer's willingness to substitute attribute at each store in the group. Similarly, between 1 and 10 product attributes (the same attribute can be chosen multiple times) that are visible to customers, like product price and pack size, can be chosen and aligned with another set of unique customer attribute multiplets.

Each customer's purchase preference as a function of the discrete or continuous valued product attribute is adjusted based on statistical interactions amongst the product attribute and customer attribute multiplets. Each statistical interaction, between product and customer attributes to impact purchase preference probabilities or between customer attributes to effect willingness to substitute, takes the general form of a weighted sum of vector functions summed over their input variables to calculate a percentage adjustment value (Eq. [1]) that cannot be less than −1 (equivalent to 100% decrease), and cannot exceed 10 (1000% increase). Users can adjust these limits as desired, and specific interactions (Eqs. [2]-[4]) can include up to as many vectorized functions as there are independent attributes.

For each statistical interaction, the attributes are chosen first, then between one and five deterministic functions are picked and assigned to the attribute multiplets in the interaction. The deterministic functions used can be any finite real or complex valued function, such as the linear function, sine function, imaginary exponential function, logistic function, square root function, and exponential function. If multiple interactions affect the same dependent variable (purchase probability or willingness to substitute attribute), then relative interaction strengths can be assigned so that different interactions have different or similar impacts on the dependent variable. The Iᵢ values in Eqs. [1]-[4] are interaction strength magnitudes, and the aᵢ variables are customer attributes.

$$Δ A = {I}_{1} ⋆ ( {\sum }_{j = 1}^{3} \vec{f} ( \vec{{a}_{J}} ) ) + {I}_{2} ⋆ ( {\sum }_{j = 4}^{4} \vec{g} ( \vec{{a}_{J}} ) ) + {I}_{3} ⋆ ( {\sum }_{j = 5}^{6} \vec{h} ( \vec{{a}_{J}} ) ) + … \qquad [ 1 ]$$

$$Δ ( willingness to substitute ) = {I}_{1} ⋆ [ exp ( {( - 1 )}^{n} ⋆ {a}_{1} ⋆ {a}_{2} ) + exp ( {( - 1 )}^{n - 1} * {a}_{3} * {a}_{4} ) ] + {I}_{2} * [ {sin ( - 1 )}^{n} * {a}_{5} ] \qquad [ 2 ]$$

$$Δ ( preference vs price {s}_{i} ) = {I}_{1} * [ \frac{2}{exp ( - {s}_{i} * {( - 1 )}^{n} ) + 1} - 1 ] + {I}_{2} * [ {( - 1 )}^{n} * sign ( {a}_{1} ) \sqrt{\vert {a}_{1} \vert} ] ⋆ \\ [ 0.5 ( {( - 1 )}^{n - 1} * {a}_{2} * {a}_{3} + {( - 1 )}^{n - 2} * {a}_{4} * {a}_{5} + {( - 1 )}^{n - 3} * {a}_{6} ) ] \qquad [ 3 ]$$

$$Δ ( preference vs pack size {p}_{i} ) = \\ [ {sin ( - 1 )}^{n} * {p}_{i} ] * [ 0.5 ( {( - 1 )}^{n - 1} * {a}_{1} * {a}_{2} + {( - 1 )}^{n - 2} * {a}_{3} * {a}_{4} + {( - 1 )}^{n - 3} * {a}_{5} * {a}_{6} + {( - 1 )}^{n - 4} * {a}_{7} * {a}_{8} * {a}_{9} * {a}_{10} ) ] \qquad [ 4 ]$$

The willingness to substitute equation can be evaluated once for each customer, and each product preference equation can be evaluated once for each customer and each unique product attribute value. In one embodiment, the multiplier values of the form (−1)ⁿ inside each interaction function can be described as Grassmann variables under addition, and the integer value for each exponent n can be extracted from a dictionary based on the attributes being used. This dictionary has a unique key:value pair for each unique attribute multiplet (singlet, pair, triplet, and the like) that exists inside any interaction function. Each key is a unique attribute multiplet, and the value for all keys is initialized to 1. Each time a specific attribute multiplet is assigned to an interaction for a store group, the current multiplet key's value in the dictionary is incremented by 1, then the updated value is used as the exponent n when the interaction value (adjustment) is computed. This value, and thus the exponent n, remains the same for all uses of a particular attribute multiplet in the same store group, and changes only when the same attribute multiplet is used in an interaction within another store group.

Adjustments to customers' willingness to substitute attribute and product purchase preferences are made sequentially by PoP group (all PoPs within the same group are subject to the same interactions as a function of product and customer attributes), so two consecutive PoP groups with the same attribute multiplet interaction have different signs (+1/−1) multiplying each attribute multiplet. As an example, customers of PoPs in PoP groups 1 and 2 both have their willingness to substitute attribute adjusted by the same two-way interaction between the logistic function of customer income (denominated in thousands of dollars) and primary buyer age:

$$Δ ( willingness substitute ) = \frac{2}{exp ( Income ⋆ age ⋆ {( - 1 )}^{n} ) + 1} - 1 \qquad [ 5 ]$$

Customers of PoP group 1 are updated first, thus the value of n associated with income*age is 1 (initial value)+1 (first store group processed)=2, so the exponent argument is always a large positive number, the logistic function asymptotes to −1, and each customer's willingness to substitute decreases by 1*100=100 percent. In PoP group 2 the same interaction is used, but since the exponent n is 3, the logistic function asymptotes to 1, and each customer's willingness to substitute doubles. Specific customer examples of the original and post-adjustment willingness to substitute attribute are shown for PoP groups 1 and 2 in Table 4.

TABLE 4
Specific customer original and post-interaction adjusted
values of the willingness to substitute attribute.

| PoP | | | Original | | | Adjusted |
|---|---|---|---|---|---|---|
| Group | PoP | Customer | willingness | Income | | willingness |
| # | # | # | to substitute | ($k) | Age | to substitute |
| 1 | 1 | 1 | 0.5 | 19.2 | 24 | 0.0 |
| 1 | 1 | 2 | 0.1 | 45.8 | 33 | 0.0 |
| 2 | 18 | 1 | 0.6 | 25.3 | 20 | 1.2 |
| 2 | 18 | 2 | 0.22 | 100.5 | 61 | 0.44 |

In one embodiment of the synthetic world, during each time period (hour, day, week, and the like) customers associated with every PoP are randomly selected and sent to one or more PoPs to buy products based on their known purchase preference probabilities, and can substitute products when faced with new assortments. As customers make purchases, an emulation of the real inventory management system used by retailers automatically orders new inventory. Additionally, users can simulate promotions like price discounts and product displays (which in one embodiment can temporarily increase inventory capacity), changes to each product's inventory capacity over time, and price increases due to inflation or other reasons. If any customer leaves a PoP on multiple occasions without being able to make a purchase or a substitution purchase they initially desired, a user can control how many times a customer will tolerate this before deciding to switch to a different PoP (in the model). Daily sales and reported inventory (including any phantom amounts) data generated in the synthetic world can be processed by the assortment optimization framework, and new assortments, including inventory capacities for each item, can be recommended. The optimization framework may not have access to data indicative of the true phantom inventories, true customer purchase preferences, how many customers have decided to never to return to a PoP after any amount of time, or any other information that is difficult to collect or measure in the real world. The differences between recommended assortment changes and true optimal assortment changes can reveal biases in the optimization framework that can be mitigated or potentially even removed through subsequent algorithm and/or training data improvements. Generally, the synthetic world allows users to test different hypotheses about consumer behavior, like how often customers buy products impulsively without advanced planning, and to improve the assortment optimization framework to make optimal recommendations with minimal risk.

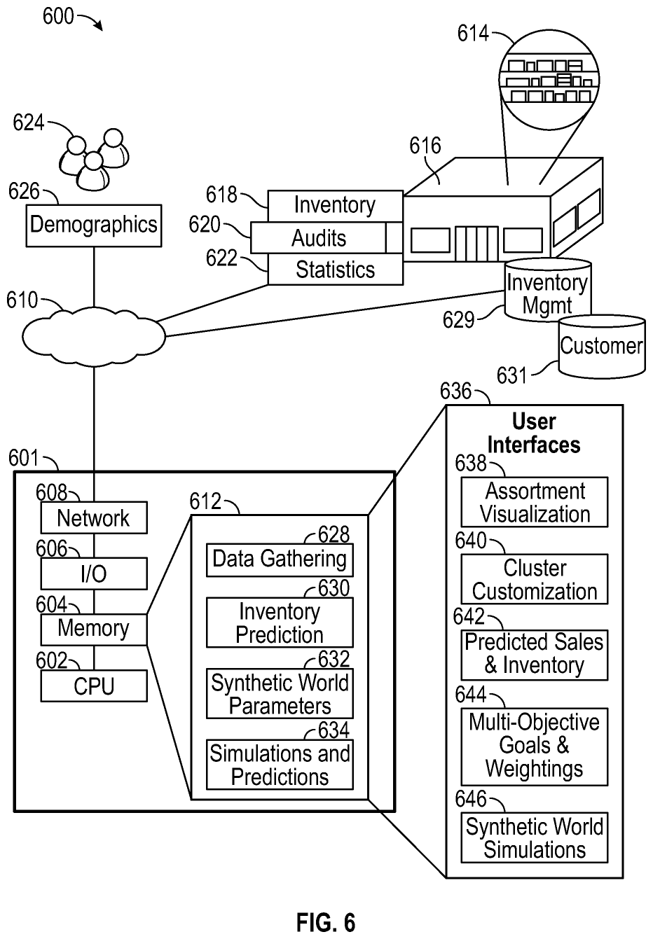

In FIG. 5, a flowchart shows high-level method steps and algorithmic processes according to an exemplary embodiment. Initial inputs are behavioral choice empirical data 502 which includes sales and inventory data with an unspecified number of instances of unavailable products, during which behavior choice can be studied. Store attributes 503 comprise geographic information, demographic and economic features of customers, and current assortments for each PoP. Product attributes 504 are the price customers pay, the cost of inventory replenishment, and the profit the retailer and product manufacturer each earns by selling one unit of each product.

Other inputs may include one or more of retailer, manufacturer, and/or other stakeholder optimization goals 506-508 and business objectives, including their relative importance, that should be optimally achieved by changing assortments. Block 509 shows how weights are applied to define the relative importance. Store assortment hard constraints 510 are rules and limits at each PoP, such as finite shelf space that should be respected by new assortments.

These inputs 502-504, 506-510 are sufficiently general to define a broad phase space of different assortments to explore, but with enough specificity to identify mathematically optimal assortments to test across many PoPs.

The processing components that process the initial inputs include product unavailability and behavioral choice modeling algorithms 512 that process the sales and inventory data, customer data, and PoP attributes data, to identify when any product is unavailable for purchase, and to study instances of unavailable products to quantify customer substitution preferences. Data from all PoPs is processed, can be aggregated across multiple PoPs that are similar in the many-dimensional space of PoPs and customer attributes, to reduce uncertainties and the effects of such uncertainties on the predicted substitution probabilities.

Another processing component includes the assortment optimization modeling and multi-objective optimization algorithms 513 that ingest the business objectives 506-508, the relative importance of each objective 509, and PoP assortment hard constraints 510 and build a smooth, high-dimensional manifold that represents all possible assortments that could be tested, and their impact on business objectives. Providing specific consumer substitution probabilities can project this manifold into a lower-dimensional space where potential optimal assortments can be identified for each PoP.

The outputs of the algorithms may include a predicted optimal assortment 516 at each PoP including the inventory capacity assigned to each product, which is an assortment that maximally achieves all business objectives and maximizes the amount of new knowledge about customer substitution preferences expected in the future. Predicted optimal clusters 517 are blocks of PoPs that may share similar customer attributes and substitution probabilities. In each block, some PoPs can be chosen to receive new assortments (test samples), and the remaining can retain the same assortment (control samples) from a different round of assortment experiments or use other assortments that are not expected to affect the comparison between test and control samples. A predicted delta for each goal 518 quantifies the expected net change in each business objective per PoP when the new optimal assortments are assigned to PoPs in each cluster.

A subsequent processing option includes a protocol 520 to simultaneously validate and improve future model predictions that randomly picks PoPs in each cluster to be test samples (change assortment) and control samples, based on any user specified criteria, like the results of prior assortment experiments, the time elapsed since the last round of experiments, and the cost of changing assortments. To minimize bias, the test PoPs and their new assortments can be chosen randomly. The protocol is executed 522 in test PoPs by implementing new assortments in test PoPs that respect the assortment hard constraints 510. Over time, new sales and inventory data 524 is fed back into behavioral choice empirical data 502, and comparison of test and control samples automatically fuels improvements to the unavailability prediction, consumer substitution behavior, and multi-objective optimization assortment change recommendation algorithms.

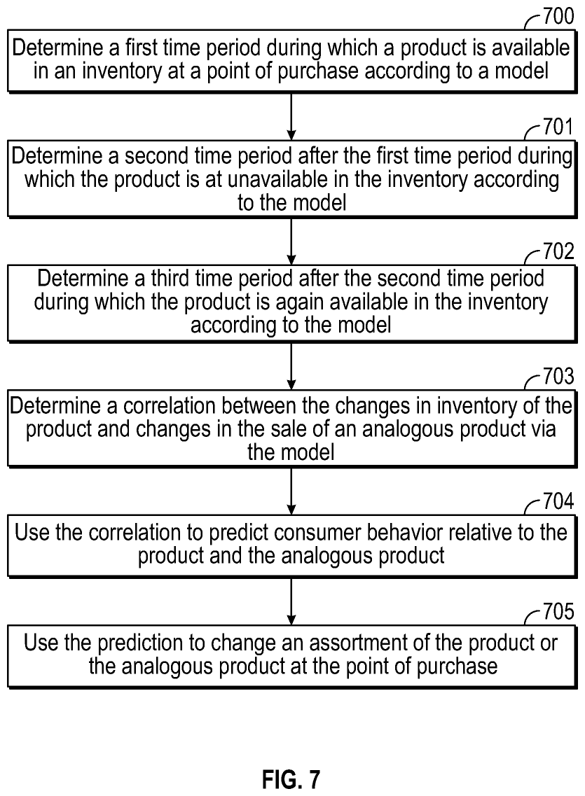

Generally, the processes described above can be integrated into a computer-implemented inventory management and control system. In FIG. 6, a block diagram shows an inventory management system 600 according to an example embodiment. The system 600 includes one or more computing devices, represented by device 601. The device 601 includes computing hardware such as a central processing unit (CPU) 602, memory 604 (e.g., random access memory, persistent memory), and input/output (I/O) circuitry 606. CPU 602 may include, be, or be part of several types of microprocessors or processing circuitry, including, but not limited to, fixed function circuitry, programmable circuitry, digital signal processors (DSPs), application specific integrated circuits (ASICs), discrete logic circuitry, and/or any other suitable hardware component(s). A network interface 608 facilitates accessing local and wide area networks 610. Note the functions of the system 600 may be distributed among a plurality of such devices and may be operable on a cloud computing service. Memory 604 in some examples functions as a computer-readable storage device or non-transitory computer-readable storage medium encoded with instructions that, when executed by the processing circuitry represented by CPU 602, perform one or more of the techniques described herein.

The device 601 is encoded with or otherwise has access to programs 612 that are operable by the CPU 602 to gather data related to a PoP 614, which in this example is a sales area inside or nearby a PoP 616, but may also apply to pick-up orders and online sales. The gathered data may include inventory data 618 that is collected by sales terminals and receiving personnel, e.g., by electronically gathering counts via bar codes, radio-frequency identification (RFID) tags, manual entry, or other means. The gathered data may be augmented by audits 620, which involve hand counts of available-for-purchase inventory of selected products. Other data may be gathered for use by the system 600, as indicated by statistics 622. The statistics 622 may include counts of customer traffic, environmental factors that may affect traffic (e.g., weather), or other relevant data. Also, demographics 626 and other statistics may be gathered about customers 624 of the store 616 and/or the region in which the store 616 is located.

Based on the gathered data, the programs 612, when executed by the processing circuitry represented by CPU 602, may form processes that perform several different functions. Part of these functions include data gathering 628 which may involve gathering initial and near-real-time data from various sources, such as an inventory management database 629 and customer relations database 631. One function provided via the execution of programs 612 by the processing circuitry represented by CPU 602 includes inventory prediction 630, which involves predicting the actual availability of select items versus what is reflected in the inventory database 629. This prediction 630 can be used to infer substitution behavior probabilities, and may be useful on its own, e.g., to alert store managers of phantom inventory so that timely replacement stock can be placed and/or ordered.

The programs 612 also process synthetic world parameters 632 that allow an end user to set up parameters for any PoPs and products of interest. These parameters 632 can be initially established and updated based on feedback from ongoing data gathering 628. Generally, the synthetic world enables users to test precision and accuracy of the system's assortment change recommendations and all prerequisite predictions 634 through simulations of customers with specific attributes and interactions between attributes and purchase preferences. In addition, the synthetic world can diagnose the sensitivity of inventory replenishment strategies to replenishment logic and customer demand and can identify improvements to replenishment strategies to reduce product unavailability instances. The functions provided by the simulations and predictions module 634 is reflected in a user interface component 636.

System 600 provides functions via user interface 636, such as assortment visualization 638 which allows modeling current arrangements and proposed changes thereto. A cluster customization 640 allows visualizing clusters of related products and the effects of changes to the clusters. A predicted sales and inventory 642 provide predictions based on changes to existing arrangements and/or new arrangements. A multi-objective goals and weighting component 644 allows changing goals that may be location specific or may change with different corporate priorities, e.g., increase profit, increase traffic, establish long-term customer loyalty, and the like. The outputs of any of these functions can be parameters that are input to the synthetic world simulations 646, which provides numerous text and graphical presentation of simulation results.

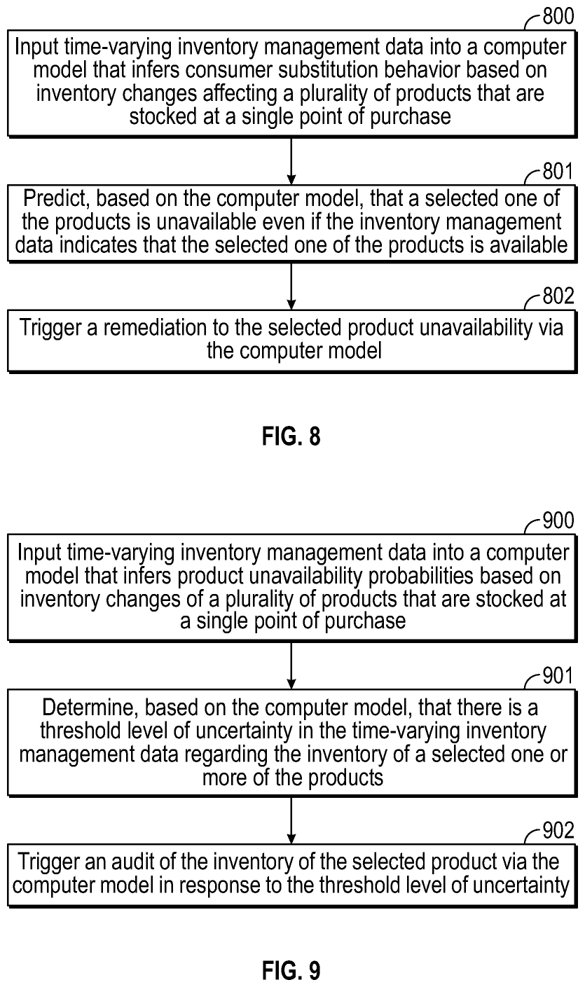

In FIG. 7, a flowchart shows a method according to an example embodiment to predict substitution behavior and subsequently change an assortment. The method involves determining 700 a first time period during which a product is available in an inventory at a point of purchase according to a model that uses time-varying inventory data from an inventory management computing system as one input. A second time period after the first time period is determined 701 during which the product is unavailable in the inventory according to the model. A third time period is determined 702, for instance after the second time period, during which the product is available in the inventory according to the model. A correlation is determined 703 between the changes in inventory of the product (available or unavailable) and changes in the sale of an analogous product via the model (which is a form of unavailability effect). The correlation is used 704 to predict consumer behavior relative to the product and the analogous product, and the prediction is used 705 to change an assortment of the product or the analogous product at the PoP.

In FIG. 8, a flowchart shows a method according to another example embodiment. The method involves inputting 800 time-varying inventory management data into a computer model that infers consumer substitution behavior based on inventory changes affecting a plurality of products that are stocked at a single PoP. Based on the computer model, a prediction 801 is made that a selected one of the products is unavailable even if the inventory management data indicates that the selected one of the products is available. A remediation is made 802 in response to the selected product unavailability via the computer model.

In FIG. 9, a flowchart shows a method according to another example embodiment to predict when products are unavailable and execute an inventory audit. The method involves inputting time-varying inventory management data into a computer model that infers product unavailability probabilities based on inventory changes and sales of a plurality of products that are stocked at specific PoPs. Based on the computer model, it is determined 901 that there is a threshold level of uncertainty in the time-varying inventory management data regarding the inventory of one or more products at each PoP. Inventory audits of all products are triggered 902 via the computer model at PoPs where the expected value of reducing predicted inventory uncertainty is high. Reducing this uncertainty proportionally improves the precision of customer substitution predictions and the predicted net business value of making specific assortment changes at a PoP.

The various embodiments described above may be implemented using circuitry, firmware, and/or software modules that interact to provide particular results. One of skill in the art can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination and are not meant to be limiting, but purely illustrative. It is intended that the scope of the invention be limited not with this detailed description, but rather determined by the claims appended hereto.

1. A method, comprising:
determining a first time period during which a first product is available in an inventory at a point of purchase according to a model that uses (a) sales data, (b) inventory data, or (c) both sales data and inventory data, wherein the inventory data comprises data from an inventory management system, sampled during the first time period, as an input;
determining a second time period during which the first product is unavailable in the inventory according to the model;
comparing a first time period sales data to a second time period sales data to determine a product unavailability effect;
and using the product unavailability effect to change an assortment at the point of purchase.

2. The method of claim 1, further comprising determining a third time period during which the first product is available in the inventory, and comparing a third time period sales data to (a) the first time period sales data, (b) the second time period sales data, or (c) both the first time period sales data and the second time period sales data, to determine the product unavailability effect.

3. The method of claim 1, wherein the model further uses demographic attributes of customers of the point of purchase as an input.

4. The method of any of claim 1, wherein the inventory data further comprises inventory data from an audit of product inventory at the point of purchase as an input.

5. The method of claim 4, wherein the audit is (a) performed by a person, (b) performed by a robot, or (c) performed by a robot and validated by human review.

6. The method of claim 1, wherein changing the assortment comprises one or more of (a) changing an amount of the product in the assortment, (b) changing a characteristic of the product in the assortment, (c) changing an amount of a second product in the assortment, or (d) changing a characteristic of the second product in the assortment.

7. The method of claim 1, wherein determining a product unavailability effect comprises forming a hidden Markov model using one or more consumer substitution probabilities, and using the hidden Markov model in a computer simulation to predict changes is sales based on changing the assortment.

8. The method of claim 1, wherein determining a product unavailability effect comprises performing a multivariate analysis of covariance to identify items {Y} having rolling average daily sales that covary with the first product going from the first time period to the second time period, and applying a random forest regression to items {Y} as a function of daily sales of other items {X}.

9. The method of claim 1, wherein determining the second time period comprises inferring that the first product is unavailable even though the first product is shown as available in the inventory management system.

10. The method of claim 9, wherein inferring that the first product is unavailable comprises determining a covariance between (a) a change in a first product inventory value at a first time T1 and a first product inventory value at a second time T2 and (b) a change in a first product replenished inventory value, using a Markov chain, to provide an availability inference.

11. The method of claim 10, further comprising evaluating the accuracy of the availability inference of the first product, wherein the evaluating comprises auditing the availability of the first product at the point of purchase.

12. The method of claim 9, wherein inferring that the first product is unavailable comprises determining a random forest regression of time-varying sales data, the random forest regression being used by a support vector machine classification to classify the first product as being unavailable.

13. A method comprising creating a synthetic world, comprising using the product unavailability effect determined by the method of claim 1 to determine a first predicted sales data for a proposed product assortment.

14. The method of claim 13, further comprising using customer purchase preferences to determine the first predicted sales data, wherein the customer purchase preferences are based on statistical interactions amongst one or more product attributes and customer attribute multiplets.

15. The method of claim 1, wherein the product unavailability effect comprises a consumer leaving the point of purchase without making a purchase due to unavailability of the first product.

16. The method of claim 1, further comprising changing the assortment of the first product at a plurality of points of purchase.

17. A system comprising:
an inventory management system that tracks inventory data of a first product at a point of purchase;
an inventory prediction model operable via a processor and configured to:
predict periods of unavailability of the first product using the inventory data, the periods of unavailability based on a probability that the product is unavailable;
based on a relationship between changes in the inventory of a second product during the periods of unavailability of the first product, form a prediction of a product unavailability effect in sales data of the first product and the second product; and
a user interface configured to receive input from a user entered via the user interface and operable to facilitate predicting, via the inventory prediction model, the product unavailability effect.
